(19) United States
(12) Patent Application Publication
(10) Pub. No.: US 2022/0318616 A1
(43) Pub. Date: Oct. 6, 2022

(54) PREDICTIVE MAINTENANCE USING VIBRATION ANALYSIS OF VANE PUMPS

(71) Applicant: Delaware Capital Formation, Inc., Wilmington, DE (US)

(72) Inventors: Atish P. Kamble, Arlington, MA (US); Prem Swaroop, Lexington, MA (US); Bodhayan Dev, Marlborough, MA (US); Nicholas Möller, Grand Rapids, MI (US)

(21) Appl. No.: 17/223,525

(22) Filed: Apr. 6, 2021

(51) Int. Cl. G06N 3/08; G06N 3/04

(52) U.S. Cl. CPC G06N 3/08; G06N 3/0445

(57) ABSTRACT

Among other things, techniques are described for predictive maintenance using vibration analysis of vane pumps. Sensor data is obtained and pre-processed the sensor data according to at least one feature extraction system. The features are extracted from the pre-processed sensor data and classified into at least one operating condition. A representation of the at least one operating condition is rendered at a device.

### FIELD OF THE INVENTION

The present techniques relate to predictive maintenance using vibration analysis of vane pumps.

### BACKGROUND

Machinery refers to a driven mechanical structure that applies forces and controls movement to execute one or more actions. Generally, a machine converts power input to the machine into a specific application of output forces and movement. Machine elements include, for example, structural components, movement control components, and general control components. Structural components include frame members, bearings, axles, splines, vanes, shafts, fasteners, seals, and lubricants. Movement control components include gear trains, belt or chain drives, linkages, and cam and follower mechanisms. General control components include buttons, switches, indicators, logic, sensors, actuators and computer controllers.

### BRIEF DESCRIPTION OF THE DRAWINGS

FIG. 1A is an illustration of a system configured to convert mechanical energy into fluid flow energy.

FIG. 1B is an illustration of a vane pump with a rotor in a first position.

FIG. 1C is an illustration of a vane pump with a rotor in a second position.

FIG. 1D is an illustration of a vane pump with a rotor in a third position.

FIG. 2 is a graph that illustrates flow rate as a function of differential pressure.

FIG. 3 is a block diagram of a physics-based model for predictive maintenance using vibration analysis of vane pumps.

FIG. 4 is a block diagram of a wavelet transforms in conjunction with a convolutional neural network for predictive maintenance using vibration analysis of vane pumps.

FIG. 5 is a block diagram of an LSTM-based model for predictive maintenance using vibration analysis of vane pumps.

FIG. 6 is a process flow diagram of a process that generates isolated pump vibration data.

FIG. 7 is a process flow diagram of a process that enables predictive maintenance using vibration analysis of vane pumps.

FIG. 8 is a block diagram of an example computer system.

### DETAILED DESCRIPTION

In the following description, for the purposes of explanation, numerous specific details are set forth in order to provide a thorough understanding of the present invention. It will be apparent, however, that the present invention can be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. Vibration Data Generation
3. Physics-based Top Feature in Conjunction with Machine-Learning Based Classifier
4. Wavelet-transforms in conjunction with Convolutional Neural Network (CNN)
5. LTSM-Deep-Learning Architecture (Auto-Feature Extraction-Classification)
6. Predictive Maintenance Using Vibration Analysis of Vane Pumps

### General Overview

Rotating machines (e.g., vane pumps, motors, fans, compressors, turbines) operate, in large part, due to the rotation of machine components. For example, vane pumps generally employ a number of vanes that travel along sliding and an out of a rotating rotor and making contact with the pump cavity. Vibrations produced by the rotating machinery are indicative of various operating conditions. These vibrations are measured using one or more sensors. The sensor data is pre-processed according to feature extraction system applied to the sensor data. The extracted features are classified to obtain a prediction of an operating condition of a rotating machine. In some cases, predictions from a plurality of feature extraction systems are determined and a final prediction is generated by combining the predictions from each individual feature extraction system.

To train the models employed by one or more feature extraction systems, the present techniques enable capture of isolated pump vibration data. In particular, the rotating machine is isolated, and components that are sources of vibration are eliminated. Vibration data associated with at least one predetermined operating condition of the rotating machine is generated, and the generated vibration data is a clean representation of rotating machine vibration under the operating condition, free from noise or vibrations that originate from sources other than the rotating machine.

Some of the advantages of these techniques include automated identification of operating conditions associated with rotating machinery. The present techniques eliminate reliance on a manual operator that could overlook or be unaware of dangerous operating conditions. Additionally, the present techniques enable efficient detection of poor operating conditions. Poor operating conditions can be damaging to industrial machinery. Further, broken down, out of operation machinery can cause significant delays further down in the production line, and could potentially be unsafe for operators. The present techniques reduce delays by preventing breakdowns associated with poor operating conditions. Moreover, the present techniques are able to recognize the fault modes in the received sensor data, even with the high-dimensional characteristics of the derived features.

### System Overview

As used herein, “sensor(s)” includes one or more hardware components that detect information about the environment surrounding the sensor. Some of the hardware components can include sensing components (e.g., vibration sensors, accelerometers), transmitting and/or receiving components (e.g., laser or radio frequency wave transmitters and receivers, transceivers, and the like), electronic components such as analog-to-digital converters, a data storage device (such as a RAM and/or a nonvolatile storage), software or firmware components and data processing components such as an ASIC (application-specific integrated circuit), a microprocessor and/or a microcontroller.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The present techniques include various artificial intelligence (AI) models that are trained using data generated while one or more predetermined operating conditions exist. A number of constraints are applied to a setup of the rotating machine and other equipment used during to generate data. The trained models can subsequently be executed on data captured during real-time operation of a rotating machine. In an embodiment, the trained models output a prediction of one or more operating conditions currently affecting the rotating machine during operation of the rotating machine. In this manner, the present techniques identify operating conditions of the rotating machine without downtime.

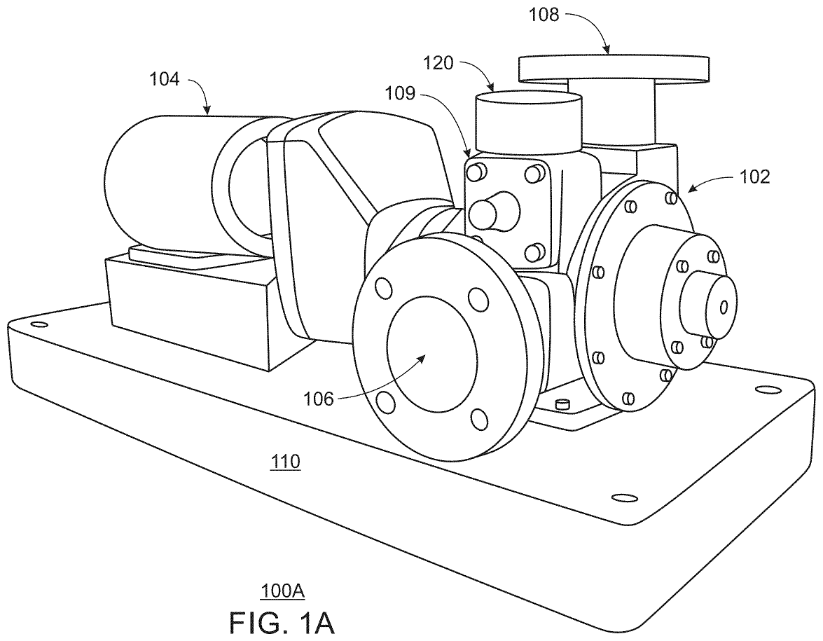

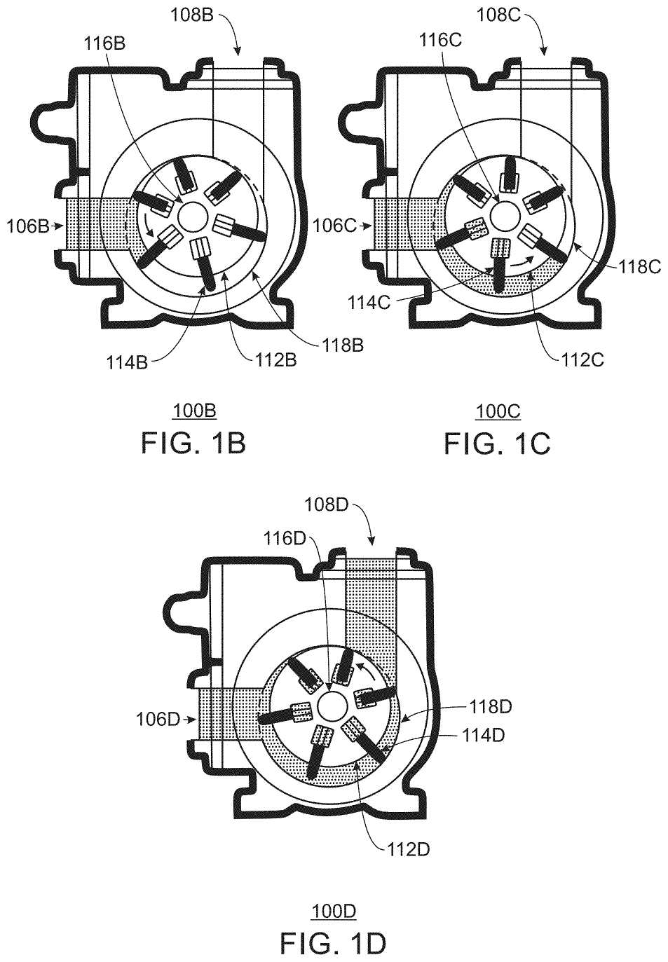

FIG. 1A is an illustration of a system 100A configured to convert mechanical energy into fluid flow energy. The system 100A includes a rotating machine 102. In the example of FIG. 1A, rotating machine 102 is a vane pump. For ease of description, the present techniques are described using a vane pump. However, the present techniques can be applied to any machinery that produces vibrations indicative of an operating condition.

Vane pumps are ubiquitous in industrial applications where fluid needs to be moved quickly from one place to another (e.g., loading and unloading transports, fueling equipment, chemical processing, refrigeration, liquid terminals, etc.). Vane pumps are continuously in operation in these industries under various conditions (e.g., chemical process, energy, transport military and marine, general industrial, oil and gas, etc.). Certain working conditions can be damaging to the pump. Additionally, a broken down, out of operation pump can cause significant delays further down in the production line, and could potentially be unsafe for operators.

The system 100A is a positive fluid displacement system. As illustrated, the rotating machine 102 is coupled with a motor 104. During operation, the motor 104 converts electrical energy to mechanical energy. The mechanical energy output by the motor 104 is used to drive rotations of a rotor within the rotating machine 102. In an embodiment, the motor is coupled with a rotor of the rotating machine 102 via a drive shaft (not illustrated).

Fluid enters the rotating machine 102 at the inlet 106, and fluid exits the rotating machine 102 at the outlet 108. Generally, internal components of the rotating machine 102 create a void at the inlet 106 draw fluid into the rotating machine 102. Fluid is transferred from the inlet 106 to discharge through the outlet 108 using the internal components. In an embodiment, the internal components of the rotating machine 102 force fluid out of the rotating machine. The rotating machine 102 includes a relief valve (RV) 109. In an embodiment, the RV 109 prevents the rotating machine 102 from creating a dangerous high-pressure situation.

In an embodiment, the present techniques include the training and execution of an AI model to identify operating conditions in real time for an operating rotating machine. For this purpose, the model analyzes vibrations of the rotating machine 102 as captured by a sensor 120. In an embodiment, the sensor is an accelerometer. Generally, an accelerometer converts mechanical forces that occur during a change in motion to an electrical current. In an example, the sensor 120 is a three-axis accelerometer. A three-axis accelerometer converts mechanical forces that occur during a change in motion along thee axes to an electrical current. In an embodiment, a plurality of sensors are mounted in multiple locations on the rotating machine 102 to measure and record vibration data in real time. In an embodiment, the accelerometer is mounted atop of a relief valve.

In an embodiment, the rotating machine 102 and motor 104 are attached to a foundation 110. In an embodiment, the foundation 110 is an isolation block for employed during data generation. The isolation block isolates the rotating machine 102 and motor 104 from other components that can introduce vibrations during data generation. For ease of illustration, the foundation 110 is illustrated as being of a particular size relative to the rotating machine 102. However, the foundation 110 can be of any size. As used herein, isolation includes fixing the component to an independent foundation as compared to the foundation of the surrounding environment. For example, within a structure such as a building, factory, or test site, a portion of the foundation and flooring of the structure is removed and a separate foundation is built to form an isolation block. Accordingly, an isolation block is a separate structure erected directly on the earth. In addition to an isolation block, other vibration attenuation techniques or components may be used to isolate the rotating machine. For example, pipe supports, bearing supports, and other impact absorption features can be implemented.

The block diagram of FIG. 1A is not intended to indicate that the system 100A is to include all of the components shown in FIG. 1A. Rather, the system 100A can include fewer or additional components not illustrated in FIG. 1A (e.g., additional pumps, drive system components, tanks, piping, valves, heat exchangers, fluids, vanes, rotors, housings, inlets, cavities, outlets, isolation blocks, laser alignment equipment, vibration analyzers, data acquisition (DAQ) systems and the like. The system 100A may include any number of additional components not shown, depending on the details of the specific implementation. Furthermore, any of the models, sensors, vibration analyzers, and other described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

FIGS. 1B, 1C, and 1D are an illustration of vane pumps 100B, 100C, and 100D, respectively. In an embodiment, the vane pumps 100B, 100C, and 100D are rotating machines (e.g., rotating machine 102 of FIG. 1). In the example of FIG. 1B, a pump inlet 106B and pump outlet 108B are illustrated. The pump 100B includes a rotor 112B and vanes 114B driven by a shaft 116B within a pump cylinder 118B. Similarly, in the example of FIG. 1C, a pump inlet 106C and pump outlet 108C are illustrated. The pump 100C includes a rotor 112C and vanes 114C driven by a shaft 116C within a pump cylinder 118C. In the example of FIG. 1D, a pump inlet 106D and pump outlet 108D are illustrated. The pump 100D includes a rotor 112D and vanes 114D driven by a shaft 116D within a pump cylinder 118D. Accordingly, in the example of FIGS. 1B, 1C, and 1D, the interior of the vane pump is illustrated. Although not illustrated, during operation the vane pump is driven by a drive system including a motor (e.g., motor 104 of FIG. 1). Generally, the rotors 112B, 112C, and 112D are illustrated as circular with any number of slots. The rotor 112B, 112C, or 112D rotates within the pump cylinder 118B, 118C, 118D, driven by a motor coupled to a shaft 116B, 116C, 116D. As the rotor turns, vanes 114B, 114C, 114D (illustrated as solid black bars) move in and out of rotor slots.

FIG. 1B illustrates a rotor 112B as fluid enters the pump cylinder 118B, in a first position. FIG. 1C illustrates the rotor 112C as fluid fills the pump cylinder 118C, in a second position. FIG. 1D illustrates the rotor 112D in a third position as fluid fills the pump cylinder 118D and exits though the outlet 108D. In an embodiment, the centers of the pump cylinder 118 and the rotor 112 are offset, causing eccentricity. During operation, vanes slide into and out of the rotor slots and seal on all edges, creating chambers within the vane pump that fill with fluid pulled in by a vacuum at the respective inlet. In particular, when the pump shaft turns the rotor in the pump housing, centrifugal force, push rods, and pressurized fluid cause the vanes to move outward in their slots, and bear against the inner bore of the pump cylinder to form pumping chambers. The fluid is transferred within the pump housing to the outlet. At the outlet, the vane chambers decrease in volume, expelling fluid out of the pump. In an embodiment, each revolution displaces a constant volume of fluid. In an embodiment, a single pump is used to transfer fluid in an industrial application. In another embodiment, a plurality of pumps are used to coordinate the transfer of fluid. The present techniques apply to singular pumps as well as pumps operating in coordination.

The block diagrams of FIGS. 1B, 1C, and 1D are not intended to indicate that the vane pumps 100B, 100C, and 100D, respectively, are to include all of the components shown in FIGS. 1B, 1C, and 1D. Rather, the vane pumps 100B, 100C, and 100D can include fewer or additional components not illustrated in FIGS. 1B, 1C, and 1D (e.g., additional pumps, drive system components, tanks, piping, valves, heat exchangers, fluids, vanes, rotors, housings, inlets, cavities, outlets, isolation blocks, laser alignment equipment, vibration analyzers, DAQ systems and the like). The vane pumps 100B, 100C, and 100D may include any number of additional components not shown, depending on the details of the specific implementation.

### Vibration Data Generation

During operation, various operating conditions can be detrimental to a rotating machine (e.g., rotating machine 102 of FIG. 1A, vane pump 100B of FIG. 1B, vane pump 100C of FIG. 1C, vane pump 100D of FIG. 1D). As used herein, an operating condition is a phenomenon that is observed during some form of work or production (e.g., operation) by the rotating machine. An operating condition can include one or more levels or stages that indicate an increasing severity of the operating condition. In an embodiment, the operating condition is associated with circumstances that occur during operation of the rotating machine, such as a vane pump. The operating condition can result in mechanical damages to the vane pump or the mechanical assembly. Damages include mechanical seal failure, bushing failure, pitting, broken vanes, etc. Common operating conditions of vane pumps include normal, dry run, cavitation, misalignment, flow rate, proper engagement of the relief valve, aeration, fluid crystallization, vane wear, galled rotor, seizure damage, erosion, push rod wear or damage, unusual cylinder or liner wear, damage by large particles, bearing wear or damage, rotational bending fatigue, torsional fatigue, and the like. Although particular operating conditions are described herein, the present techniques are not limited to the presently described operating conditions. Rather, the operating conditions that are detected according to the present techniques include any conditions observable while the pump is operable (e.g., being driven or supplied power).

In an example, a normal operating condition represents a regular, natural, or desired standard of operation. During a normal operating condition, the pump provides fluid transfer functionality as expected according to the inputs to the pump. By contrast, during a dry run operating condition, the pump is operating (e.g., the rotor is being driven by a motor) without fluids. Operating a vane pump without fluids can damage the pump. During misalignment, the motor or gearbox shaft is not in alignment with the pump input shaft.

During cavitation, for example, fluid boils within the pump during operation. The boiling fluid is typically due to the presence of an inlet vacuum great enough that causes pressure to drop so that fluid boils at a temperature lower than expected at atmospheric pressure. For example, a strainer upstream of the pump can be clogged or otherwise blocked, thus choking the inlet flow and causing a vacuum at the inlet. The vacuum causes small gas bubbles to form within the fluid and these bubbles will soon after collapse/implode inside the pump causing damage. Evidence of cavitation includes, but is not limited to, excessive noise and vibration.

Some operating conditions are determined based upon, at least in part, combinations of other operating conditions. For example, flow rate is an operating condition that is dependent on other operating conditions, such as speed (e.g., rotations per minute (RPM) of the motor) and differential pressure at the pump. In an embodiment, higher speeds relate directly to higher flow rates. To set a predetermined flow rate for data generation, the operating conditions on which flow rate depends are plotted and trend lines used to determine the dependent operating condition.

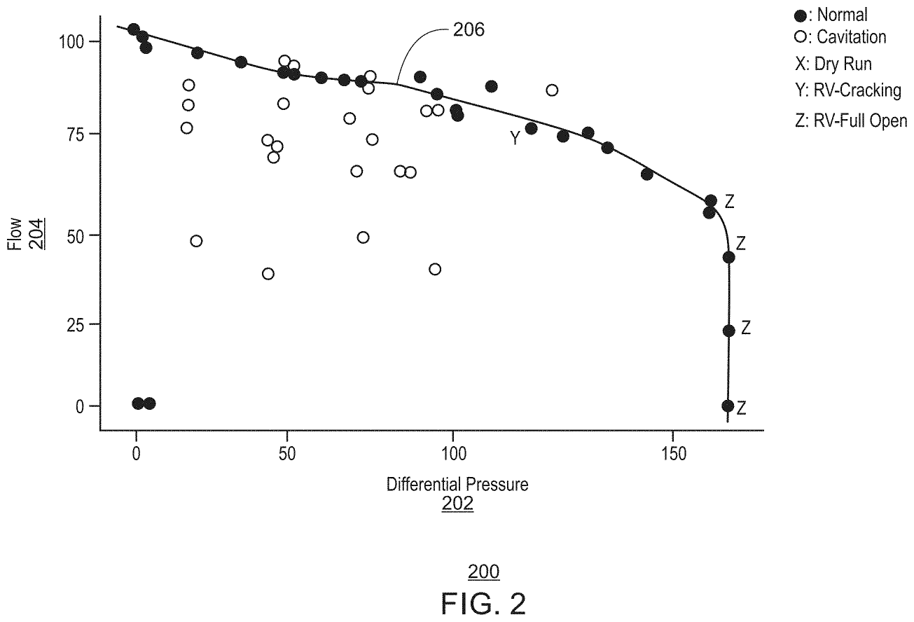

FIG. 2 is a graph 200 that illustrates flow rate as a function of differential pressure at a specific pump speed (RPM). In the graph 200, the flow rate 204 corresponds to the y-axis and differential pressure 202 corresponds to the x-axis. As illustrated on the graph 200, normal operating conditions, cavitation, dry run, relief valve cracking, and relief valve full open operating conditions are plotted. In an embodiment, relief valve cracking refers to the initial opening of the relief valve, and relief value full open refers to when the valve is fully open. The relief valve is active after a relief valve cracking event occurs. Initially, when the relief valve “cracks” open, there is generally a smaller area available for relief (e.g., fluid transfer) when compared to the fully open relief valve. Generally, when the relief valve is active, some fluid exits the pump via the relief valve. While particular operating conditions are plotted on the graph 200, any operating conditions may be used.

A trend line 206 is overlaid on the graph 200 generally connecting the data points that represent normal operating conditions. The trend line 206 corresponds to a particular RPM. In an example, if the rotations per minute (RPM) and differential pressure are known, the flow rate can be determined by locating known values on the graph 200. In an embodiment, graph generation includes overlaying trend lines that connect normal operating conditions of the pump. For ease of illustration, a single RPM trend line is illustrated. However, multiple trend lines may be represented on the graph 200. In an embodiment, the graph 200 is created using vibration data generated under one or more predetermined operating conditions as described below. In real world vane pump operation, flow rates can be determined by locating the flow rate on the generated graph 200 using RPM (which is typically known or set) and differential pressure (which can be observed using a pressure meter). Thus, the present techniques enable a determination of flow rate without a flowmeter or other flow measurements.

Vibration data is generated while one or more operating conditions are applied to the operation of the pump. In an embodiment, a controller or processor is used to adjust control values, speed/RPM, or other variables to simulate one or more operating conditions. Predetermined operating conditions can be simulated by adjusting one or more components of a system under test, such as the motor, control valves, or pressures. Vibrations are measured or captured during data generation. In an embodiment, a vibration analyzer is used to process data captured by the sensor. For example, the vibration analyzer executes a time series analysis on the captured vibration data. Additionally, a data acquisition system (DAQ) is implemented to record system parameters such as speed, pressure, temperature, etc. In an embodiment, speed, power, and torque are measured via data acquisition device in the shaft system of the vane pump. In an embodiment, differential pressure is monitored and adjusted using control valves.

In an embodiment, one or more three axis accelerometers (e.g., sensor 120 of FIG. 1A) are coupled with the vane pump. In embodiments, the accelerometer captures data associated with vibrations caused by the pump. The vibration data captured is isolated pump vibration data associated with the one or more predetermined operating conditions. As used herein, isolated pump vibration data is raw accelerometer data representative of vibrations generated by a vane pump, without noise or vibrations from other sources. Isolated pump vibration data is generated under one or more constraints. The constraints include, for example, such as an isolation block, a laser aligned setup, and a variable frequency driven (VFD) motor. As a result, isolated pump vibration data is a clean representation of rotating machine vibration under the operating condition, free from noise or vibrations that originate from sources other than the rotating machine (e.g., gearbox).

For example, equipment used to develop the isolated vane pump vibration data includes an isolation block (e.g., foundation 110 of FIG. 1) to prevent exterior vibrations from interfering with testing. In an example, the isolation block is a large foundation that is independent of the building foundation. This foundation has a large mass of its own and is not directly connected to the foundation of the building. Accordingly, the foundation can dampen any vibration that might originate from the factory floor, highway, across the street, and the like. In an example, the motor and the pump are directly coupled with the isolation block. In an embodiment, a gearbox is not present in the system used for data generation. By eliminating gearboxes, the chance of generating any tooth-mesh or bearing frequencies from the gearbox when generating isolated pump vibration data is eliminated. Other equipment associated with operating the vane pump, such as a drive shaft system, tanks, piping, valves, heat exchangers, and test fluid are used to complete the system for testing. The other equipment may be coupled with the vane pump and motor using flexible piping and couplings to reduce any vibrations from the other equipment. In an embodiment, the vane pump is mounted on an independent base bolted to isolation block.

Laser alignment equipment is used to verify, measure, and define one or more levels of misalignment. In an embodiment, multiple levels of misalignment determined. The levels of alignment can include, for example, near-perfection (e.g., aligned), within approved limits (e.g., slightly aligned, slightly misaligned, within a predetermined range or threshold), and not aligned (e.g., misaligned, heavily misaligned). In an embodiment, one or more levels of alignment are tested with the presence of any combination of other operating conditions, such as normal, dry run, cavitation, flow rate, proper engagement of the relief valve, aeration, fluid crystallization, vane wear, galled rotor, seizure damage, erosion, push rod wear or damage, unusual cylinder or liner wear, damage by large particles, bearing wear or damage, rotational bending fatigue, torsional fatigue, and the like. Isolated pump vibration data is generated with a large number of test runs with various permutations of the operating conditions.

The motor provides further constraints when generating isolated pump vibration data. In an embodiment, the motor (e.g., motor 104 of FIG. 1) used to drive the vane pump is a direct drive high power electric motor with variable frequency drive (VFD) control. For the purposes of data generation, a greatly overpowered (for a standard application) motor is used and then driven at lower power frequencies to achieve a range of speeds. The motor is run at lower speeds during data generation, enabling electrical reduction (VFD) of RPMs instead of a mechanical reduction (gearbox). In this manner, any vibrations due to mechanical reductions in speed are eliminated. Thus, testing can be performed at multiple speeds, and the use of a gearbox is eliminated, as a gearbox can introduce additional vibrations that can add noise to or otherwise corrupt the isolated pump vibration data. Traditional vibration based fault diagnostic methods are limited to a constant speed and load.

To accurately characterize the vibrations generated under one or more predetermined operating conditions, a high number of tests are executed on a vane pump with constraints as described above. During each test, one or more predetermined operating conditions are replicated and isolated pump vibration data is generated as the vane pump operates. One or more accelerometers coupled with the vane pump captures the isolated pump vibration data. In an example, 1,269 runs of a test pump are executed to isolate the effects of predetermined operating conditions. Accordingly, the present techniques generate isolated pump vibration data by executing a large number of runs on a constrained vane pump. During isolated pump vibration data generation, the vibration data is logged at a high rate for a set period of time to enable a significant data population size. In an embodiment, the isolated pump vibration data along with the one or more predetermined operating conditions are used to train one or more models that enable predictive maintenance using vibration analysis of vane pumps. Additionally, in an embodiment real-world vibration data associated with the predetermined operating conditions is obtained and used to refine the isolated pump vibration data captured under the constraints using real-world vibration data. For example, real world data is obtained though beta testing.

Physics-Based Top Feature in Conjunction with Machine-Learning Based Classifier

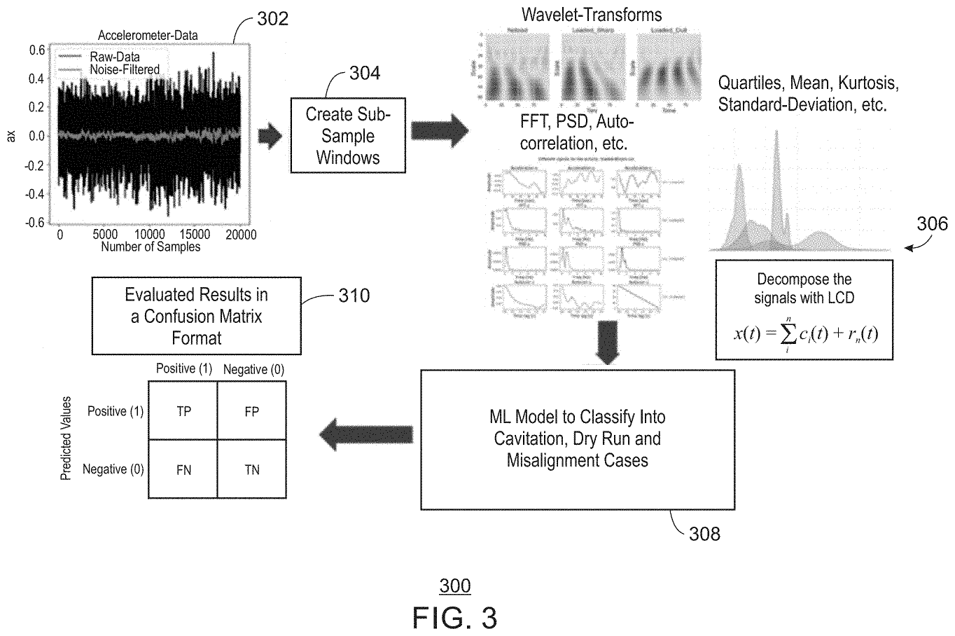

FIG. 3 is a block diagram of a physics-based model 300 for predictive maintenance using vibration analysis of vane pumps. FIG. 3 includes vibration data 302. In an example, vibration data 302 is captured during operation of a rotating machine (e.g., rotating machine 102 of FIG. 1, vane pump 100B of FIG. 1C, vane pump 100C of FIG. 1C). The rotating machine may be, for example, a vane pump. The vibration data 302 may be captured by one or more sensors (e.g., sensor 120 of FIG. 1). At block 304, subsample windows are created from the captured vibration data 302. In an embodiment, subsample windows include measurements captured at regular time intervals. In an embodiment, subsample windows include measurements captured at irregular time intervals. Additionally, at block 304 the data may be further preprocessed according to the particular feature extraction system. Generally, the preprocessing as described herein modifies the vibration data so that it can be processed by the corresponding feature extraction system. For example, pre-processing converts the sensor data from a raw format to an other format. In an embodiment, the preprocessing can vary according to the particulars of the feature extraction system used.

At reference number 306, a plurality of feature extraction systems is illustrated. As used herein, a feature extraction system is one or more processes, techniques, or components used to characterize data input to the feature extraction system. In the example of FIG. 3, feature extraction systems include wavelet transforms, statistical feature extraction (e.g., quartiles, mean, kurtosis, standard deviation, etc.), and time series feature extraction (e.g., fast Fourier transform (FFT), power spectral density (PSD), auto-correlation, etc.). In an embodiment, the feature extraction system outputs a feature vector. In an embodiment, a dimensionality of the output of feature extraction system 306 is reduced using principal component analysis (PCA). For example, PCA reduces the dimensionality of the output by projecting each data point onto a first few principal components to obtain lower dimensional data while preserving as much of the data's variation as possible. Additionally, in an embodiment, t-distributed stochastic neighbor embedding (t-SNE), Principal Component Analysis and Linear Discriminant Analysis are introduced to reduce the dimensionality of the feature vectors.

At block 308, the output of the one or more feature extraction systems is obtained by a machine learning (ML) model. The machine learning model predicts one or more operating conditions by classifying the data output by the feature extraction system into the one or more operating conditions. In an example, the machine learning model is a decision-tree-based ensemble machine learning algorithm that uses a gradient boosting framework (e.g., XGBoost). In an example, the machine learning model is a supervised learning algorithm consisting of a number of decision trees that are averaged (e.g., Random Forest). Additionally, in an example, the machine learning model as described herein is linear algorithm based on a cost function defined as a sigmoid function (e.g., logistic regression).

Accordingly, the at least one operating condition is identified by a likelihood operating condition exists based on the sensor data. In an example, the machine learning based classifier uses training data (e.g., isolated pump vibration data) to determine how the extracted features relate to one or more operating conditions. In the example of FIG. 3, the one or more operating conditions are cavitation, dry run, and misalignment. However, a machine learning model according to the present techniques can classify data output by a feature extraction system into any operating condition where the machine learning model was trained using isolated pump vibration data associated with the operating condition. At block 310, the performance of the machine learning model in predicting the one or more operating conditions is evaluated in a confusion matrix format. In embodiments, evaluation of the classification in a confusion matrix format enables visualization of the performance of the classifier.

Accordingly, FIG. 3 classifies real time data output by a rotating machine into one or more operating conditions using models trained with isolated pump vibration data. In an embodiment, vibration data from a vane pump operating at a client site, under real world operating conditions is captured. For example, real world vibration data is from vane pumps that are continuously in operation in a variety of industries, such as chemical process, energy, transport, military and marine, general industrial, oil and gas, etc. The vibration data captured during real world operation (e.g., vibration data 302) of a vane pump is sampled. In particular, the real world vibration data is divided into subsample windows.

Generally, the feature extraction system decomposes the vibration data into a feature space. A feature is information regarding properties of the vibration data. For example, a feature is a particular characteristic in the data that is extracted using time domain techniques, frequency domain techniques, or any combination thereof. In an example, a feature extraction system applied to the vibration data is a wavelet transform. A wavelet transform is a mathematical function used to divide a given function or continuous time signal into different scale components. The wavelet transform provides frequency information with the corresponding temporal data. In an embodiment, a wavelet transform decomposes the input into wavelets of various scales in the time domain. Pre-processing data when the feature extraction system is a wavelet transform includes applying a low pass filter to raw accelerometer data to denoise the raw data. The wavelet transform is applied to the filtered data, and the resulting wavelets have variable window sizes and provide a local structure of the data in a time—frequency domain. In an example, raw accelerometer data is captured and pre-processed to raw filtered data that is reshaped into small packets of 100 subsamples, 60% training, 20% validation, and 20% test. The accelerometer data is transformed into wavelets. The wavelets may be a 128×128 resolution on scale. Wavelet transforms can be used effectively for transient feature extraction and extract signal features over the entire spectrum without a dominant frequency band. In an embodiment, the dimensionality of features extracted using wavelet transform based feature extraction is reduced via principal component analysis to transform the original extracted features into a new set of uncorrelated features. For normal, dry run, and cavitation, the wavelet patterns produced by the wavelet transforms are visually different. These distinct patterns are learned by the model during training. In an embodiment, the results according to the present techniques may be output via a confusion matrix.

In an example, a feature extraction system applied to the vibration data is a frequency domain analysis. Generally, the frequency domain analysis includes a fast Fourier transform (FFT), power spectral density (PSD), auto-correlation, and the like. The FFT translates the vibration data from the time domain into the frequency domain and features are extracted. The power spectral density of the vibration data can also be computed, and features extracted from the power spectral density. Generally, autocorrelation is the correlation of a signal with the delayed copy of itself. Features are extracted from the correlation are input to a machine learning based classifier. Pre-processing data when the feature extraction system is a frequency domain analysis includes applying a low pass filter to raw accelerometer data to denoise the raw data.

In this example, features are extracted as peak amplitudes on a chart charting against time lag in seconds. In an embodiment, for a subsample window of vibration data, the FFT, power spectral density, and autocorrelation are plotted. The peaks of each algorithm (FFT, power spectral density, and autocorrelation) are distinct and different for each of the conditions. In an embodiment, the machine learning algorithm distinguishes between conditions based on the peak of the respective frequency domain analysis plots. In another example, a feature extraction system applied to the vibration data is a statistical time domain feature extraction system. In this example, statistical time domain features include quartiles, mean, kurtosis, standard deviation, and the like.

In an embodiment, local characteristic decomposition (LCD) is used to transform the raw signals into a number of intrinsic scaled components (ISC). In the subsequent steps, any feature extraction system is applied to the ISC (e.g., FFT, wavelet transformations, kurtosis, mean, median etc.). For each feature extracted using post LCD-ISC (e.g., high dimensional features), dimensional reduction techniques like t-distributed stochastic neighbor embedding (t-SNE) or principal component analysis (PCA) are implemented. These reduced dimensional features can then be input into a machine learning based classifier for classifying into different pump conditions.

The block diagram of FIG. 3 is not intended to indicate that the model 300 is to include all of the components shown in FIG. 3. Rather, the model 300 can include fewer or additional components not illustrated in FIG. 3 (e.g., additional pre-processing, frequency domain analysis, time series feature extraction, statistical based feature extraction, machine learning models, confusion matrices, etc.) The model 300 may include any number of additional components not shown, depending on the details of the specific implementation. Furthermore, any of the described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

Wavelet-Transforms in Conjunction with Convolutional Neural Network (CNN)

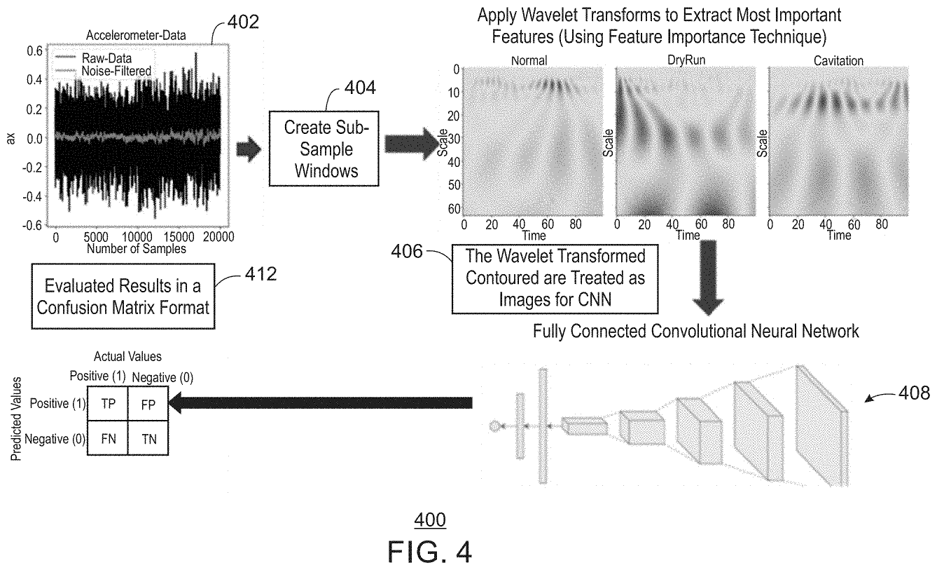

FIG. 4 is a block diagram of a wavelet transforms in conjunction with a convolutional neural network. Similar to FIG. 3, FIG. 4 includes vibration data 402. The vibration data 402 may be captured by one or more sensors (e.g., sensor 120 of FIG. 1). At block 404, subsample windows are created from the captured vibration data 402. In an embodiment, subsample windows include measurements captured at regular time intervals. In an embodiment, subsample windows include measurements captured at irregular time intervals. Additionally, at block 404 the data may be further preprocessed according to the particular feature extraction system. Generally, the preprocessing as described herein modifies the vibration data so that it can be processed by the corresponding feature extraction system. In an embodiment, the preprocessing can vary according to the particulars of the feature extraction system used.

At reference number 406, wavelet transforms are illustrated. In the example of FIG. 4, the wavelet transforms are determined using a feature importance technique. In particular, a threshold is applied to the wavelet transform to determine the most important features. As used herein, the most important features are those features that are above a predetermined threshold. In an example, raw accelerometer data is captured and pre-processed to raw filtered data that is reshaped into small packets of 100 subsamples, including training, validation, and testing packets. The wavelet transforms are ranked and input to a fully connected a convolutional neural network (CNN) 408. In an embodiment, the wavelet transforms are processed by the fully connected convolutional neural network as images. Accordingly, the CNN 408 may be a wavelet-based CNN. In an embodiment, the CNN includes several layers, including convolutional layers, subsampling layers, and fully connected layers. In the example of FIG. 4, wavelets were used as they have very distinct patterns and can be treated as images. The CNN 408 classifies the data output by the feature extraction system into one or more operating conditions. In the example of FIG. 4, the one or more operating conditions are cavitation, dry run, and misalignment. However, a machine learning model according to the present techniques can classify data output by a feature extraction system into any operating condition where the machine learning model was trained using isolated pump vibration data associated with the operating condition.

At block 412, the performance of the machine learning model in predicting the one or more operating conditions is evaluated in a confusion matrix format. In embodiments, evaluation of the classification in a confusion matrix format enables visualization of the performance of the classifier.

The block diagram of FIG. 4 is not intended to indicate that the model 400 is to include all of the components shown in FIG. 4. Rather, the model 400 can include fewer or additional components not illustrated in FIG. 4 (e.g., additional pre-processing, wavelet transforms, CNNs, machine learning models, confusion matrices, etc.) The model 400 may include any number of additional components not shown, depending on the details of the specific implementation. Furthermore, any of the described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

### LTSM-Deep-Learning Architecture (Auto-Feature Extraction-Classification)

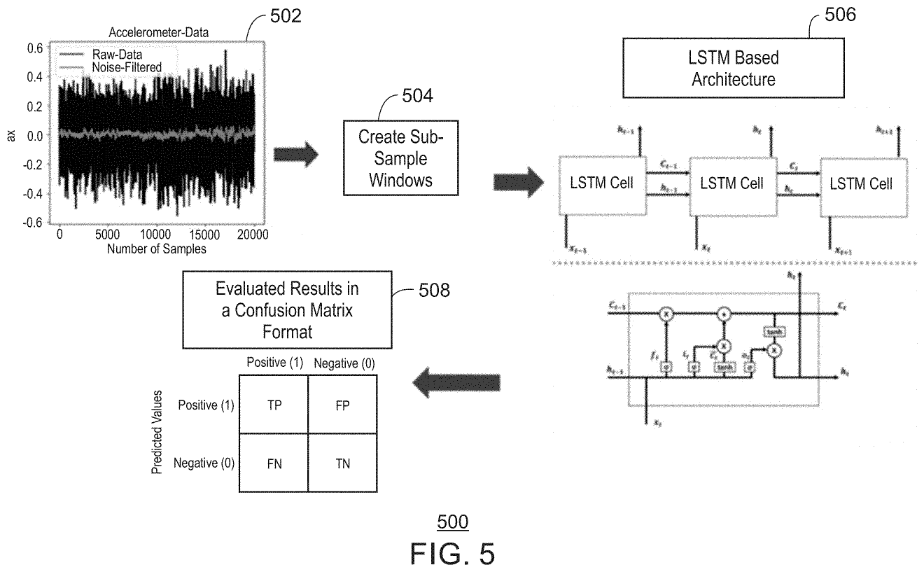

FIG. 5 is a block diagram of an LSTM-based model. Similar to FIG. 3, FIG. 5 includes vibration data 502. The vibration data 502 may be captured by one or more sensors (e.g., sensor 120 of FIG. 1). At block 504, subsample windows are created from the captured vibration data 502. In an embodiment, subsample windows include measurements captured at regular time intervals. In an embodiment, subsample windows include measurements captured at irregular time intervals. Additionally, at block 504 the data may be further preprocessed according to the particular feature extraction system. Generally, the preprocessing as described herein modifies the vibration data so that it can be processed by the corresponding feature extraction system. In an embodiment, the preprocessing can vary according to the particulars of the feature extraction system used.

At reference number 506, a long short-term memory (LSTM) based architecture is illustrated. The LSTM processes a plurality of parallel sequences of vibration data. For example, a three axis accelerometer captures data that is associated with vibrations along the x, y, and z axes. Using an LSTM based architecture, the raw vibration data is filtered to remove noise. The LSTM then extracts features from the filtered signals and classifies the features into one or more operating conditions. In an embodiment, creating subsample windows of the raw vibration data for input into an LSTM based architecture includes partitioning the data into multiple overlapping windows. In an embodiment, the input data is classified into one or more operating conditions by using the prediction from the last time step as the classification head of the neural network. The LSTM based architecture as described herein implements a gate-based network (e.g., LTSM, Recurrent Neural Network, Gated Recurrent Units, etc.) to classify the vibration data into an operating condition without separate feature extraction for classification.

At block 508, the performance of the machine learning model in predicting the one or more operating conditions is evaluated in a confusion matrix format. In embodiments, evaluation of the classification in a confusion matrix format enables visualization of the performance of the classifier.

The block diagram of FIG. 5 is not intended to indicate that the model 500 is to include all of the components shown in FIG. 5. Rather, the model 500 can include fewer or additional components not illustrated in FIG. 5 (e.g., additional pre-processing, LTSM architectures, machine learning models, confusion matrices, etc.) The model 500 may include any number of additional components not shown, depending on the details of the specific implementation. Furthermore, any of the described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

### Predictive Maintenance Using Vibration Analysis of Vane Pumps

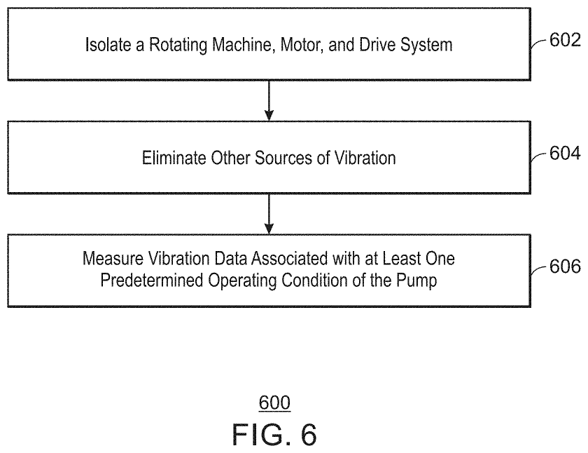

FIG. 6 is a process flow diagram of a process 600 that generates isolated pump vibration data. The example process 600 can be implemented by the system 100A of FIG. 1A and used to generate the isolated pump vibration data that is used to train the model 300 of FIG. 3, the model 400 of FIG. 4, or the model 500 of FIG. 5. In various examples, the process 600 may be implemented using the processor of the computer system 800.

At block 602 a rotating machine (e.g., rotating machine 102 of FIG. 1), motor (e.g., motor 104 of FIG. 1), and drive system are isolated. In embodiments, the rotating machine, motor, and drive system are isolated by coupling the rotating machine, motor, and drive system to an isolation block (e.g., isolation block 110 of FIG. 1). Isolating the rotating machine, motor, and drive system includes separating the rotating machine, motor and drive system such that vibrations external to the rotating machine, motor, and drive system are eliminated. For example, the rotating machine, motor, and drive system are physically isolated from other equipment associated with operating the rotating machine, such as tanks, piping, valves, heat exchangers, and test fluid.

At block 604, other sources of vibration are eliminated. For example, the other equipment associated with operating the rotating machine (and necessary to generate one or more predetermined operating conditions) are coupled with the rotating machine, motor, and drive system to generate vibration data. In an embodiment, the other equipment is mounted to other isolation blocks. In an embodiment, the other equipment is connected to the rotating machine, motor, and drive system using flexible piping to reduce any vibrations from the other equipment. At block 606, vibration data associated with one or more predetermined operating conditions of the pump is measured. In embodiments, the measured vibration data is isolated pump vibration data from the rotating machine. The isolated pump vibration data does not include noise from other sources of vibration, as the other sources of vibration are eliminated through strategic equipment placement, usage of isolation blocks, usage of flexible or vibration absorbing piping, and other vibration attenuation techniques.

The process flow diagram of FIG. 6 is not intended to indicate that the blocks of the example process 600 are to be executed in any order, or that all of the blocks are to be included in every case. Further, any number of additional blocks not shown may be included within the example process 600, depending on the details of the specific implementation.

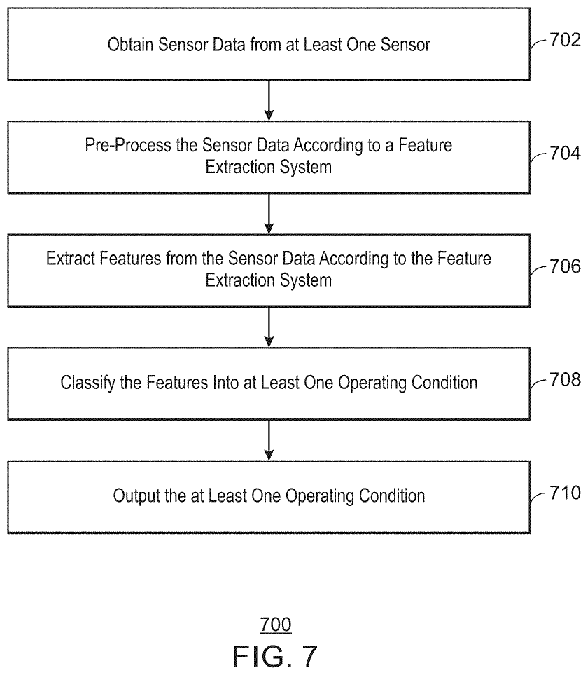

FIG. 7 is a process flow diagram of a process 700 that enables predictive maintenance using vibration analysis of vane pumps. The example process 700 can be implemented by trained models, such as the model 300 of FIG. 3, the model 400 of FIG. 4, or the model 500 of FIG. 5. In various examples, the process 700 may be implemented using trained models executing on the processor of the computer system 800.

At block 702, sensor data (e.g., vibration data 302 of FIG. 3, vibration data 402 of FIG. 4, vibration data 502 of FIG. 5) is obtained from at least one sensor (e.g., sensor 120). In an embodiment, the sensor is an accelerometer. At block 704, the sensor data is preprocessed according to a feature extraction system (e.g., reference number 306 of FIG. 3, reference number 406 of FIG. 4, reference number 506 of FIG. 5). For example, the sensor data may be used to create subsample windows (e.g., block 304 of FIG. 3, block 404 of FIG. 4, and block 504 of FIG. 5). In an embodiment, the subsample windows include measurements captured at regular time intervals. In an embodiment, subsample windows include measurements captured at irregular time intervals.

At block 706, features are extracted from the sensor data according to the feature extraction system. For example, wavelet transform features are extracted from wavelet transforms. FFT features are extracted from and FFT transform. In an embodiment, the dimensionality of the extracted features is reduced. At block 708, the features are classified into at least one operating condition. For example, operating conditions include normal, dry run, cavitation, misalignment, flow rate, proper engagement of the relief valve, aeration, fluid crystallization, vane wear, galled rotor, seizure damage, erosion, push rod wear or damage, unusual cylinder or liner wear, damage by large particles, bearing wear or damage, rotational bending fatigue, torsional fatigue, and the like. In an embodiment, the models are stress tested by running multiple error conditions at once such as dry run and misalignment. Additionally, in an embodiment, a plurality of feature extraction systems are used to extract a respective plurality of feature sets. One or more classifiers are used to classify the feature sets into respective operating condition classifications. The respective operating condition classifications are combined into a final prediction.

At block 710, the at least one operating condition is output. In an embodiment, a representation of the at least one operating condition is rendered at a device. The representation informs a user of a status of the vane pump. In an example, the user is a technician monitoring the operation of the vane pump. Analyzing accelerometer data to determine operating conditions of a vane pump cannot be directly executed by humans. Accordingly, the operating condition is output in a human observable form. As used herein, a human observable form may refer to a form that is understood by humans. For example, audio may be output that indicates an operating condition. The output may be an electronic assistant announcing the operating condition. The output may be a series of chirps, alerts, or other auditory warnings that a dangerous operating condition is occurring. A human observable form may also be visual. For example, text may be rendered or displayed that indicates an operating condition. The visual output may also be changes in lighting, blinking, or other alerts regarding one or more operating conditions.

The process flow diagram of FIG. 7 is not intended to indicate that the blocks of the example process 700 are to be executed in any order, or that all of the blocks are to be included in every case. Further, any number of additional blocks not shown may be included within the example process 700, depending on the details of the specific implementation.

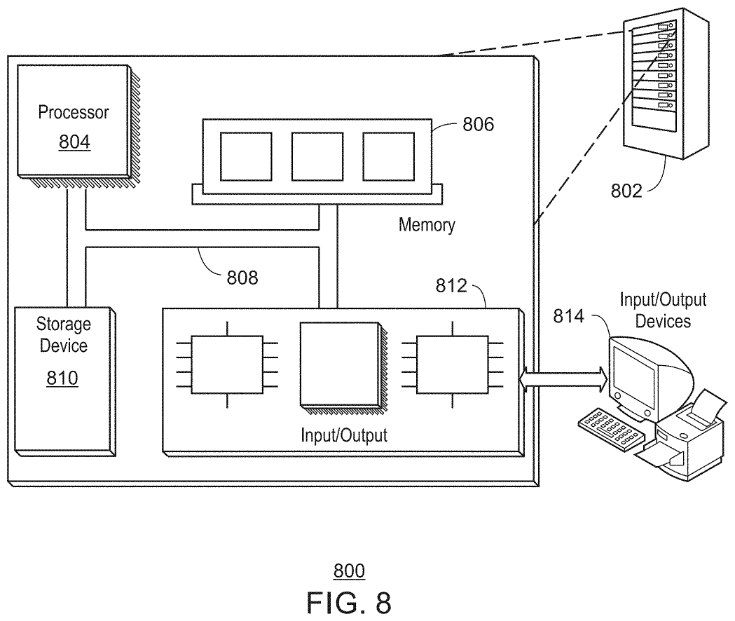

FIG. 8 is a block diagram of an example computer system 800. For example, system 100A of FIG. 1, the model 300 of FIG. 3, model 400 of FIG. 4, or the model 500 of FIG. 5 could be a part of an example of the system 800 described here. The system 800 includes a processor 804, a memory 806, a storage device 810, and one or more input/output device interfaces 812. Each of the components 804, 806, 810, and 812 can be interconnected, for example, using a system bus 850. The system

The processor 804 is capable of processing instructions for execution within the system 800. The term “execution” as used here refers to a technique in which program code causes a processor to carry out one or more processor instructions. The processor 804 is capable of processing instructions stored in the memory 806 or on the storage device 810. The processor 804 may execute operations such as isolated pump vibration data generation and predictive maintenance using vibration analysis of vane pumps. The memory 806 stores information within the system 800. In some implementations, the memory 806 is a computer-readable medium. In some implementations, the memory 806 is a volatile memory unit. In some implementations, the memory 806 is a non-volatile memory unit.

The storage device 810 is capable of providing mass storage for the system 800. In some implementations, the storage device 810 is a non-transitory computer-readable medium. In various different implementations, the storage device 810 can include, for example, a hard disk device, an optical disk device, a solid-state drive, a flash drive, magnetic tape, or some other large capacity storage device. In some implementations, the storage device 810 may be a cloud storage device, e.g., a logical storage device including one or more physical storage devices distributed on a network and accessed using a network. In some examples, the storage device may store long-term data, such as isolated pump vibration data. Preset settings corresponding to the material placed within the containment center may also be stored. The input/output interface devices 840 provide input/output operations for the system 800. In some implementations, the input/output interface devices 840 can include one or more of a network interface devices, e.g., an Ethernet interface, a serial communication device, e.g., an RS-232 interface, and/or a wireless interface device, e.g., an 802.11 interface, a 3G wireless modem, an 8G wireless modem, etc. A network interface device allows the system 800 to communicate, for example, transmit and receive such data. In some implementations, the input/output device can include driver devices configured to receive input data and send output data to other input/output devices, e.g., keyboard, printer and display devices 860. In some implementations, mobile computing devices, mobile communication devices, and other devices can be used.

A server or database system 802 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 800 is contained within a single integrated circuit package. A system 800 of this kind, in which both a processor 804 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 812.

Although an example processing system has been described in FIG. 8, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as control of a data generation, model training, and model execution can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

A number of embodiments of the invention have been described. Nevertheless, it will be understood that various modifications may be made without departing from the spirit and scope of the invention.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method, comprising:
obtaining, by at least one processor, sensor data from at least one sensor, wherein the sensor data is associated with a rotating machine;
pre-processing, using at the least one processor, the sensor data according to at least one feature extraction system, wherein pre-processing comprises converting the sensor data from a raw format to an other format;
extracting, using the at least one feature extraction system, features from the pre-processed sensor data;
classifying, using a at least one classifier, the extracted features into at least one operating condition, wherein the at least one operating condition is identified by a likelihood operating condition exists based on the sensor data; and
rendering, using the at least one processor, a representation of the at least one operating condition at a device, wherein the representation informs a user of a status of the rotating machine.

2. The method of claim 1, comprising iteratively training the feature extraction system by evaluating the operating condition classification in a confusion matrix format.

3. The method of claim 1, wherein preprocessing the sensor data comprises modifying the sensor data for input to a corresponding feature extraction system.

4. The method of claim 1, wherein extracting features from the preprocessed sensor data comprises generating one or more wavelet transforms, wherein the extracted features a wavelets.

5. The method of claim 1, wherein extracting features from the preprocessed sensor data comprises:
generating one or more wavelet transforms ranked according by feature importance; and
converting the wavelet and other transformations to contours, wherein a convolutional neural network and a machine learning based classifier is applied to classify the ranked one or more transforms.

6. The method of claim 1, wherein extracting features from the preprocessed sensor data comprises executing an LTSM based architecture that extracts features and classifies the extracted features into the at least one operating condition classification.

7. The method of claim 1, wherein the at least one sensor is a three axis accelerometer.

8. The method of claim 1, comprising:
extracting, using a plurality of feature extraction systems, a respective plurality of feature sets;
classifying, using the at least one classifier, the respective extracted plurality of features sets into respective operating condition classifications; and
combining, using the at least one processor, the respective operating condition classifications into a final prediction.

9. A system, comprising:
an isolation block, wherein a vane pump and a motor are mounted to the isolation block and the motor is overpowered and under clocked in relation to the vane pump;
at least one three axis accelerometer mounted to the vane pump to capture generated vibration data;
at least one processor; and
at least one memory storing instructions thereon that, when executed by the at least one processor, cause the at least one processor to:
simulate at least one predetermined operating condition by adjusting one or more components of the system during operation of the vane pump;
generating vibration data by iteratively modifying a level of the predetermined operating condition, wherein other sources of vibration are eliminated from the vibration data.

10. The system of claim 9, wherein a plurality of predetermined operating conditions are simulated by adjusting one or more components of the system during operation of the vane pump and vibration data is generated by iteratively modifying a level of the plurality of predetermined operating conditions.

11. The system of claim 9, wherein the at least one predetermined operating condition comprises a plurality of levels that indicate an increasing severity of the operating condition.

12. The system of claim 9, further comprising instructions that cause the at least one processor to obtain real-world vibration data associated with the at least one predetermined operating condition and refine the vibration data using real-world vibration data.

13. A system, comprising:
at least one processor; and
at least one memory storing instructions thereon that, when executed by the at least one processor, cause the at least one processor to:
obtain sensor data from at least one sensor, wherein the sensor data is associated with a rotating machine;
pre-process the sensor data according to at least one feature extraction system, wherein pre-processing comprises converting the sensor data from a raw format to an other format;
extract features from the pre-processed sensor data;
classify the extracted features into at least one operating condition, wherein the at least one operating condition is identified by a likelihood operating condition exists based on the sensor data; and
render a representation of the at least one operating condition at a device, wherein the representation informs a user of a status of the rotating machine.

14. The system of claim 13, wherein the instructions cause the at least one processor to iteratively train the feature extraction system by evaluating the operating condition classification in a confusion matrix format.

15. The system of claim 13, wherein the instructions cause the at least one processor to preprocess the sensor data comprises modifying the sensor data for input to a corresponding feature extraction system.

16. The system of claim 13, wherein the instructions cause the at least one processor to extract features from the preprocessed sensor data by generating one or more wavelet transforms, wherein the extracted features a wavelets.

17. The system of claim 13, wherein the instructions cause the at least one processor to extracting features from the preprocessed sensor data by:
generating one or more wavelet transforms ranked according by feature importance; and
converting the wavelet and other transformations to contours, wherein a convolutional neural network and a machine learning based classifier is applied to classify the ranked one or more transforms.

18. The system of claim 13, wherein the instructions cause the at least one processor to extract features from the preprocessed sensor data by executing an LTSM based architecture that extracts features and classifies the extracted features into the at least one operating condition classification.

19. The system of claim 13, wherein the at least one sensor is a three axis accelerometer.

20. The system of claim 13, wherein the instructions cause the at least one processor to:
extract a respective plurality of feature sets according to a plurality of feature extraction systems;
classify the respective extracted plurality of features sets into respective operating condition classifications according to at least one classifier; and
combine the respective operating condition classifications into a final prediction.
